(19) United States
(12) Patent Application Publication
(10) Pub. No.: US 2026/0233607 A1
(43) Pub. Date: Aug. 13, 2026

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventor: Ryo Koda, Nisshin-shi (JP)

(73) Assignee: TOYOTA JIDOSHA KABUSHIKI KAISHA, Toyota-shi (JP)

(21) Appl. No.: 19/398,314

(22) Filed: Nov. 24, 2025

(30) Foreign Application Priority Data
Feb. 13, 2025 (JP) 2025-021833

(51) Int. Cl. B60K 35/28; G06F 16/955

(52) U.S. Cl. CPC B60K 35/28; G06F 16/9554; B60K 2360/592

(57) ABSTRACT

An information processing device including a communication unit that displays a terms-and-conditions document related to a vehicle on an in-vehicle display unit includes a control unit that determines whether or not communication by the communication unit is permitted, and causes the display unit to display a two-dimensional code for accessing the server device when it is determined that communication by the communication unit cannot be performed normally.

### CROSS-REFERENCE TO RELATED APPLICATION

This application claims priority to Japanese Patent Application No. 2025-021833 filed on February 13, 2025. The disclosure of the above-identified application, including the specification, drawings, and claims, is incorporated by reference herein in its entirety.

### BACKGROUND

### 1. Technical Field

The present disclosure relates to an information processing device, an information processing method, and a storage medium.

### 2. Description of Related Art

Japanese Unexamined Patent Application Publication No. 2020-135813 (JP 2020-135813 A) describes that when receiving provision of personal information from an occupant of a vehicle, a terms-and-conditions document concerning handling of personal information and the like is displayed on an in-vehicle screen, to prompt the occupant to consent.

### SUMMARY

There are cases in which the terms-and-conditions document regarding the vehicle has been revised, and accordingly there is a need to display the latest version of the terms-and-conditions document that is managed by a server, in order to obtain valid consent of the occupant regarding the terms-and-conditions document. In a conventional configuration, when the vehicle cannot perform normal communication with the server, the latest terms-and-conditions document could not be displayed, and valid consent to the latest terms-and-conditions document could not be obtained.

An object of the present disclosure to enable obtaining of valid consent of an occupant to the latest terms-and-conditions document, even when the vehicle cannot perform normal communication.

According to the present disclosure, an information processing device that is equipped with a communication unit and that displays a terms-and-conditions document related to a vehicle on a display unit that is an in-vehicle unit, the information processing device including a control unit that determines whether communication by the communication unit is available, and displays a two-dimensional code for accessing a server device on the display unit, when determination is made that normal communication by the communication unit is not available.

According to the embodiment of the present disclosure, valid consent of the occupant to the latest terms-and-conditions document can be obtained, even when the vehicle cannot perform normal communication.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a and according to an embodiment of the present disclosure; and

FIG. 2 is a flowchart illustrating an example operation of a system according to an embodiment of the present disclosure.

### DETAILED DESCRIPTION OF EMBODIMENTS

Hereinafter, an embodiment of the present disclosure will be described with reference to the drawings. In the drawings, parts having the same configuration or function are denoted by the same reference numerals. In the description of the present embodiment, duplicate descriptions of the same parts may be omitted or simplified as appropriate.

### System 1

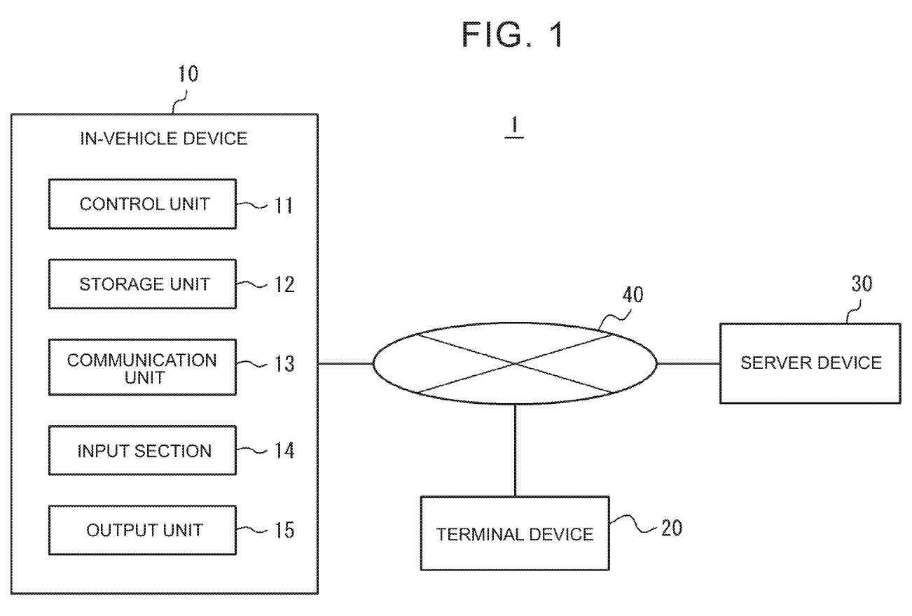

FIG. 1 is a diagram illustrating a configuration example of a system 1 according to an embodiment of the present disclosure. With reference to FIG. 1, a configuration and an outline of a system 1 according to an embodiment of the present disclosure will be described.

The system 1 includes an in-vehicle device 10, a terminal device 20, and a server device 30. The in-vehicle device 10, the terminal device 20, and the server device 30 can communicate with each other via the network 40. In FIG. 1, the in-vehicle device 10, the terminal device 20, and the server device 30 are connected to a common network 40. However, the configuration is not limited to such a configuration as long as communication is possible between the in-vehicle device 10 and the server device 30 and between the terminal device 20 and the server device 30. For example, separate communication means may be provided between the in-vehicle device 10 and the server device 30 and between the terminal device 20 and the server device 30.

The in-vehicle device 10 as the information processing device according to the present embodiment is a computer mounted on a vehicle. The in-vehicle device 10 receives an operation from an occupant of a vehicle including a driver, and executes various kinds of information processing in the vehicle. The vehicle is an arbitrary device that travels on a roadway to move a person, an object, and the like. The vehicle may be, for example, a gasoline-powered vehicle, battery electric vehicle (BEV), hybrid electric vehicle (HEV), plug-in hybrid electric vehicle (PHEV), fuel cell electric vehicle (FCEV), etc.

The terminal device 20 is a computer held by an occupant of the vehicle. The terminal device 20 includes a camera that captures an image, a display unit that displays an image (for example, a liquid crystal display or an organic EL display), and a communication unit that communicates with the server device 30 via the network 40. In the present embodiment, the terminal device 20 is a smartphone, but the terminal device 20 is not limited to this. For example, the terminal device 20 may be a general-purpose electronic device such as a tablet terminal, a wearable terminal, or a PC (Personal Computer), or a dedicated electronic device.

The server device 30 is, for example, a computer installed in a data center or the like. The server device 30 may be provided by a cloud service. The server device 30 manages the latest terms-and-conditions document regarding the handling of personal information. In response to a request from the in-vehicle device 10 and the terminal device 20, the server device 30 returns information for displaying the latest terms-and-conditions document.

The network 40 is any communication medium such as the Internet and a mobile communication network.

In FIG. 1, one each of in-vehicle device 10, in-terminal device 20, and in-server device 30 are illustrated, but system 1 may include a plurality of these devices.

In such a configuration, when acquiring the personal information from the occupant, the in-vehicle device 10 displays a terms-and-conditions document indicating the handling of the personal information in order to promote the consent of the occupant from the viewpoint of privacy protection. For example, in acquiring biometric information from an occupant or acquiring information related to traveling of a vehicle, information related to use of the in-vehicle device 10, and the like, the in-vehicle device 10 displays a terms-and-conditions document indicating handling of the information.

The in-vehicle device 10 determines whether or not communication by the communication unit 13 included in the in-vehicle device 10 is permitted, and when communication with the server device 30 can be normally performed, receives the latest terms-and-conditions document from the server device 30 and displays the received terms-and-conditions document on the display unit (output unit 15). The occupant confirms the terms-and-conditions document displayed on the display unit (output unit 15) and inputs the consent or disagreement to the in-vehicle device 10.

On the other hand, when communication by the communication unit 13 cannot be performed normally, the in-vehicle device 10 causes the display unit (output unit 15) to display a two-dimensional code including a URL (Uniform Resource Locator) for accessing the server device 30 and the like. The occupant causes the camera of the terminal device 20 to read the two-dimensional code. The terminal device 20 decodes the two-dimensional code, accesses the acquired URL, receives the latest terms-and-conditions document from the server device 30, and displays the received terms-and-conditions document on the display unit of the terminal device 20. The occupant confirms the terms-and-conditions document displayed on the terminal device 20 and inputs the consent or disagreement to the in-vehicle device 10.

Therefore, according to the configuration of the present embodiment, the in-vehicle device 10 can obtain the effective agreement of the occupant with respect to the latest terms-and-conditions document even when the vehicle cannot normally perform the communication.

### In-vehicle device 10

As illustrated in FIG. 1, the in-vehicle device 10 includes a control unit 11, a storage unit 12, a communication unit 13, an input unit 14, and an output unit 15.

The control unit 11 includes at least one processor. The processor may be a general-purpose processor such as a CPU (Central Processing Unit), or a special-purpose processor specialized for a particular process. The control unit 11 executes processing related to the operation of the in-vehicle device 10 while controlling each unit of the in-vehicle device 10.

The storage unit 12 includes at least one semiconductor memory, a magnetic memory, an optical memory, or the like. The storage unit 12 functions as, for example, a main storage device, an auxiliary storage device, or the like. The storage unit 12 stores data used for the operation of the in-vehicle device 10 and data obtained by the operation of the in-vehicle device 10.

The communication unit 13 includes at least one wireless communication interface for external communication. The wireless communication interface is, for example, an interface corresponding to a mobile communication standard such as a 5G, 6G, an interface corresponding to a wireless LAN (Local Area Network), or an interface corresponding to short-range wireless communication. The communication unit 13 receives data used for the operation of the in-vehicle device 10, and transmits data obtained by the operation of the in-vehicle device 10.

The input unit 14 includes at least one input interface. The input interface may be, for example, a physical key, a touch screen, a sound sensor (microphone) that receives voice input, a camera that receives gesture input, or the like. The input unit 14 receives an operation of inputting data used for the operation of the in-vehicle device 10.

The output unit 15 includes at least one output interface including a display unit. The display unit may be any display for outputting an image of information, for example, a liquid crystal display or an organic EL display. The output interface may further include, for example, a speaker or the like that outputs information by voice. The output unit 15 outputs data obtained by the operation of the in-vehicle device 10.

The in-vehicle device 10 may be realized by a single computer or may be realized by cooperation of a plurality of computers.

The function of the in-vehicle device 10 is realized by executing the program according to the present embodiment by a processor corresponding to the control unit 11. That is, the functions of the in-vehicle device 10 are realized by software. The program causes the computer to execute the operation of the in-vehicle device 10, thereby causing the computer to function as the in-vehicle device 10. That is, the computer functions as the in-vehicle device 10 by executing the operation of the in-vehicle device 10 in accordance with the program. In the present embodiment, the program can be recorded in a computer-readable recording medium. The computer-readable recording medium includes a non-transitory computer-readable medium, and is, for example, a magnetic recording device, a semiconductor memory, or the like. The program is distributed, for example, by selling, transferring, or lending a portable recording medium such as a DVD in which the program is recorded. Further, the program may be distributed by storing the program in the storage of the external server and transmitting the program from the external server to another computer. The program may also be provided as a program product. The program is stored in a storage medium. Some or all of the functions of the in-vehicle device 10 may be realized by a dedicated circuit corresponding to the control unit 11. That is, some or all of the functions of the in-vehicle device 10 may be realized by hardware.

### Example of Operation

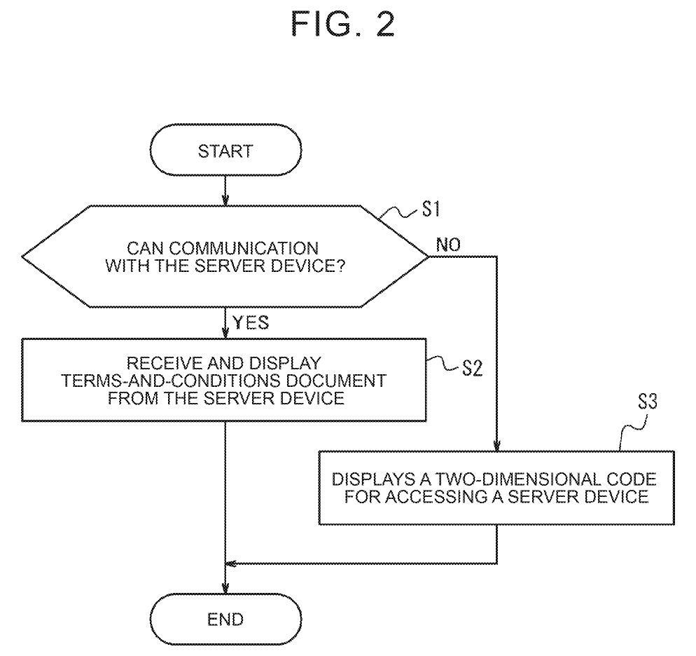

FIG. 2 is a flowchart illustrating an operation example of the system 1 according to an embodiment of the present disclosure. The operation of the system 1 described with reference to FIG. 2 may correspond to one of the information processing methods of the information processing device. The operation of each step in FIG. 2 may be executed under the control of the control unit 11 of the in-vehicle device 10.

S1: The control unit 11 determines whether or not the in-vehicle device 10 can normally communicate with the server device 30 by the communication unit 13. When communication with the server device 30 is normally enabled (YES in S1), the control unit 11 proceeds to S2, and otherwise (NO in S1), proceeds to S3.

The control unit 11 may determine whether or not communication between the server device 30 and the communication unit 13 is possible by any known method. For example, the control unit 11 may determine whether or not communication with the server device 30 is possible based on the reception strength of radio waves from the base station of the mobile communication network, the reception status of acknowledgement of a packet to an external device such as the base station or the server device 30, or the like.

S2: The control unit 11 receives the latest terms-and-conditions document from the server device 30 and displays it on the display unit (the output unit 15).

Specifically, the control unit 11 transmits a signal requesting the latest terms-and-conditions document to the server device 30. Upon receiving the terms-and-conditions document from the server device 30 in response to the request, the control unit 11 displays the received terms-and-conditions document on the display unit (output unit 15). The occupant can check the latest terms-and-conditions document on the screen of the display unit (output unit 15). Upon completion of S2, the control unit 11 ends the flowchart of FIG. 2.

S3: The control unit 11 causes the display unit (the output unit 15) to display a two-dimensional code for accessing the server device 30.

For example, the control unit 11 may cause the display unit (the output unit 15) to display QR code generated by encoding URL of the server device on which the newest terms-and-conditions document is posted. The occupant can read the two-dimensional code by the camera of the terminal device 20, access URL indicated by the two-dimensional code, and confirm the latest terms-and-conditions document on the screen of the terminal device 20. Upon completion of S3, the control unit 11 ends the flowchart of FIG. 2.

After confirming the latest terms-and-conditions document displayed on the in-vehicle device 10 or the terminal device 20, the occupant inputs to the in-vehicle device 10 whether or not to agree with the terms-and-conditions document. The in-vehicle device 10 controls the handling of the personal information in response to the consent or disagreement of the occupant.

As described above, the in-vehicle device 10 is a computer that includes the communication unit 13 and displays the terms-and-conditions document regarding the vehicle on the in-vehicle display unit (output unit 15). The in-vehicle device 10 determines whether or not communication by the communication unit 13 is possible. When it is determined that communication by the communication unit 13 cannot be performed normally, a two-dimensional code for accessing the server device 30 is displayed on the display unit (output unit 15). The two-dimensional code may indicate, for example, a URL of the server device 30 on which the most recent terms-and-conditions document is posted. When it is determined that communication by the communication unit 13 can be performed normally, the in-vehicle device 10 receives the latest terms-and-conditions document from the server device 30 and causes the display unit (output unit 15) to display the received terms-and-conditions document.

As described above, the in-vehicle device 10 automatically determines the means for accessing the latest terms-and-conditions document according to the state of communication performed by the communication unit 13 of the in-vehicle device 10. Therefore, according to the in-vehicle device 10, even when communication by the communication unit 13 cannot be performed normally, the occupant can read the two-dimensional code from the terminal device 20 and access the server device 30 to confirm the latest terms-and-conditions document. Therefore, even when the vehicle cannot perform communication normally, the in-vehicle device 10 can obtain the valid agreement of the occupant with respect to the latest terms-and-conditions document. Since the system 1 manages the latest terms-and-conditions document in the server device 30, only the server device 30 side needs to be updated when updating the agreement, and the agreement update can be immediately reflected in the system 1.

The present disclosure is not limited to the above-described embodiments. For example, a plurality of blocks described in a block diagram may be integrated, or one block may be divided. The steps described in the flowcharts may be performed in parallel or in a different order depending on the processing capability of the device performing each step, or as needed, instead of being performed in time series according to the description. Other modifications can be made without departing from the spirit of the present disclosure.

Hereinafter, some of the embodiments of the present disclosure will be exemplified. It should be noted, however, that embodiments of the present disclosure are not limited thereto.

### Appendix 1

An information processing device including a communication unit that displays a terms-and-conditions document regarding a vehicle on an in-vehicle display unit, wherein the information processing device includes a control unit that determines whether or not communication by the communication unit is permitted, and causes the display unit to display a two-dimensional code for accessing a server device when it is determined that communication by the communication unit cannot be normally performed.

### Appendix 2

The information processing device according to [Appendix 1], wherein the two-dimensional code indicates a URL of the server device on which the newest terms-and-conditions document is posted.

### Appendix 3

The information processing device according to [Appendix 1] or [Appendix 2], wherein, when it is determined that communication by the communication unit can be performed normally, the control unit receives the latest terms-and-conditions document from the server device and causes the display unit to display the received terms-and-conditions document.

### Appendix 4

An information processing method of an information processing device including a communication unit and a control unit that displays a terms-and-conditions document related to a vehicle on an in-vehicle display unit, wherein the control unit determines whether or not communication by the communication unit is permitted, and when it is determined that communication by the communication unit cannot be performed normally, causes the display unit to display a two-dimensional code for accessing the server device.

### Appendix 5

A computer is an information processing device provided with a communication unit which displays a terms-and-conditions document about vehicles on an in-vehicle display unit, and it determines propriety of communication by the aforementioned communication unit, and when it is determined that communication by the aforementioned communication unit cannot be performed normally, A program which operates as an information processing device provided with a control unit which displays a two-dimensional code for accessing a server device on the aforementioned display part.

What is claimed is:

1. An information processing device that is equipped with a communication unit and that displays a terms-and-conditions document related to a vehicle on a display unit that is an in-vehicle unit, the information processing device comprising a control unit that
determines whether communication by the communication unit is available, and
displays a two-dimensional code for accessing a server device on the display unit, when determination is made that normal communication by the communication unit is not available.

2. The information processing device according to claim 1, wherein the two-dimensional code indicates a URL of the server device in which a latest version of the terms-and-conditions document is posted.

3. The information processing device according to claim 1, wherein, when determination is made that normal communication by the communication unit is available, the control unit receives the latest version of the terms-and-conditions document from the server device and causes the display unit to display the terms-and-conditions document that is received.

4. An information processing method of an information processing device that is equipped with a communication unit and a control unit and that displays a terms-and-conditions document regarding a vehicle on a display unit that is an in-vehicle unit, wherein the control unit
determines whether communication by the communication unit is available, and
displays a two-dimensional code for accessing a server device on the display unit, when determination is made that normal communication by the communication unit is not available.

5. A non-transitory storage medium storing a program that causes a computer to function as an information processing device that is equipped with a communication unit and that displays a terms-and-conditions document related to a vehicle on a display unit that is an in-vehicle unit, the information processing device including a control unit that
determines whether communication by the communication unit is available, and
displays a two-dimensional code for accessing a server device on the display unit, when determination is made that normal communication by the communication unit is not available.
